(19) United States
(12) Patent Application Publication
(10) Pub. No.: US 2026/0344619 A1
(43) Pub. Date: Nov. 5, 2026

(54) SYSTEMS AND METHODS FOR TRAINING A PET

(71) Applicant: Evelyn KLIMOWICZ, Ridgefield, CT (US)

(72) Inventor: Evelyn KLIMOWICZ, Ridgefield, CT (US)

(21) Appl. No.: 19/196,248

(22) Filed: May 1, 2025

(51) Int. Cl. A01K 15/02

(52) U.S. Cl. CPC A01K 15/021; A01K 15/026

(57) ABSTRACT

Systems and methods for training domestic pets are described. A system includes an alarm, configured to emit a signal for a duration. The system further includes a pet toy dispenser. The pet toy dispenser includes an enclosure, wherein the enclosure is configured to open or close in response to a wireless input. The system also includes a food-infusible pet toy within the enclosure. A method includes receiving a wireless signal at an enclosure, activating the alarm in response to the wireless signal, opening the door of the enclosure in response to the wireless input thereby exposing a food-infusible pet toy; and closing the door following the predetermined length of time.

### TECHNICAL FIELD

This invention relates to pet care, and more particularly to systems and methods for training a pet.

### BACKGROUND

Domestic pets occasionally exhibit undesirable behaviors in the home, particularly in response to exciting stimuli. These exciting stimuli might include a caretaker returning to the home, a stranger visiting the home, or a caretaker departing the home. In their excitement, domestic pets may bite, scratch, bark, or otherwise behave in ways that could be destructive, obtrusive, or harmful.

A variety of pet toys and training systems are popular. Chew toys, for example, provide pets stimulation through pleasurable tactile or gustatory sensations. Automatic food dispensers, as another example, train pets to seek out food at regular intervals in fixed locations. These and other devices directed toward the care and training of domestic pets redirect potentially destructive energy but fail to adequately accommodate caretakers' need to consistently and remotely engage their pet under a variety of circumstances.

It is therefore desirable to provide a system which allows for redirecting the excitement of a pet through positive reinforcement, consistency in response to various exciting stimuli, and remote operation.

### SUMMARY

According to some embodiments, a system for training pets comprises an enclosure, which comprises a first wall; a second wall, wherein a first edge of the second wall is coupled to a first edge of the first wall; a third wall, wherein a first edge of the third wall is coupled to a second edge of the second wall; a ceiling, wherein a first edge of the ceiling is coupled to a second edge of the first wall, a second edge of the ceiling is coupled to a third edge of the second wall, and a third edge of the ceiling is coupled to a second edge of the third wall; a floor, wherein at least a portion of the floor is removably coupled to at least a third edge of the first wall, a fourth edge of the second wall, or a third edge of the third wall, wherein the floor has an adjustable height, and at least a portion of the floor is detachable from the enclosure; a door, wherein the door is operably coupled to at least one of the first wall, second wall, third wall, ceiling, or floor such that the enclosure substantially surrounds a volume defined by the first wall, second wall, third wall, ceiling, floor, and door, wherein the door is configured to open to render an interior of the enclosure accessible and configured to close to render the enclosure impenetrable to pets; an alarm, proximate to the enclosure, wherein the alarm is configured to emit a signal perceptible to a pet; a food-infusible pet toy, located within the interior of the enclosure and removably coupled to the enclosure, such that, when the door is open, the food-infusible pet toy is accessible to the pet, wherein the food-infusible pet toy comprises a non-toxic, inedible surface; a handle, operably coupled to the non-toxic, inedible surface; and, a plurality of texture elements, coupled to the non-toxic, inedible surface; and, a control system, wherein the control system is configured to cause the door to open or close, and the alarm to emit the signal, in response to a user input.

In some embodiments, the signal perceptible to a pet is configured by a user to include at least one of an auditory, olfactory, visual, or vibratory signal.

In some embodiments, the food-infusible pet toy is removably coupled to the enclosure by at least one coupling requiring human manual dexterity to uncouple. In some embodiments, the food-infusible pet toy is removably coupled to the enclosure by a key-locked mechanism. In some embodiments, the food-infusible pet toy is removably coupled to the enclosure by a double-sided spring-loaded mechanism.

In some embodiments, a portion of the ceiling is removable.

In some embodiments, the door is further configured to open and the alarm is configured to emit a signal perceptible to a pet in response to a user-defined condition. In some embodiments, the door is further configured to close following a user-defined condition. In some embodiments, the user-defined condition is a length of time. In some embodiments, wherein the alarm is further configured to emit a signal perceptible to a pet prior to closing.

According to some embodiments, a method for training a pet comprises receiving a wireless signal via a wireless receiver configured to receive a wireless signal from a wireless transmitter; activating an alarm in response to the wireless signal, wherein activating the alarm comprises emitting a signal perceptible to a pet; opening a door of an enclosure in response to the wireless signal, wherein opening the door renders a food-infusible pet toy, that is removably coupled to the enclosure, accessible to the pet, and wherein the enclosure comprises: a first wall; a second wall, wherein a first edge of the second wall is coupled to a first edge of the first wall; a third wall, wherein a first edge of the third wall is coupled to a second edge of the second wall; a ceiling, wherein a first edge of the ceiling is coupled to a second edge of the first wall, a second edge of the ceiling is coupled to a third edge of the second wall, and a third edge of the ceiling is coupled to a second edge of the third wall; a floor, wherein at least a portion of the floor is removably coupled to at least a third edge of the first wall, a fourth edge of the second wall, or a third edge of the third wall, wherein the floor has an adjustable height, and at least a portion of the floor is detachable from the enclosure; and the door, wherein the door is operably coupled to at least one of the first wall, second wall, third wall, ceiling, or floor such that the enclosure substantially surrounds a volume defined by the first wall, second wall, third wall, ceiling, floor, and door, wherein when the door is open the interior of the enclosure is accessible and wherein the enclosure is impenetrable to pets when the door is closed; and closing the door following a predetermined length of time, thereby rendering the food-infusible pet toy inaccessible to the pet.

In some embodiments, the signal perceptible to a pet is configured by a user to include at least one of an auditory, olfactory, visual, or vibratory signal.

In some embodiments, the non-toxic, inedible surface is removably coupled to the enclosure by at least one coupling requiring human manual dexterity to uncouple.

In some embodiments, the non-toxic, inedible surface is removably coupled to the enclosure by a key-locked mechanism.

In some embodiments, the non-toxic, inedible surface is removably coupled to the enclosure by a double-sided spring-loaded mechanism.

In some embodiments, a portion of the ceiling is removable.

In some embodiments, the door is further configured to open and the alarm is configured to emit a signal perceptible to a pet in response to a user-defined condition. In some embodiments, the door is further configured to close following a user-defined condition. In some embodiments, the user-defined condition is a length of time. In some embodiments, the method further comprises reactivating the alarm following the predetermined length of time.

### BRIEF DESCRIPTION OF THE FIGURES

Various objectives, features, and advantages of the disclosed subject matter can be more fully appreciated with reference to the following detailed description of the disclosed subject matter when considered in connection with the following drawings, in which like reference numerals identify like elements:

FIGS. 1A-1C are graphical representations of a system for training a pet, according to some embodiments of the present disclosure;

FIGS. 2A-2B are graphical representations of a system for training a pet, according to some embodiments of the present disclosure;

FIG. 3 is a graphical representation of a system for training a pet, according to some embodiments of the present disclosure;

FIGS. 4A-4B are graphical representations of a system for training a pet, according to some embodiments of the present disclosure;

FIGS. 5A-5B are graphical representations of a food-infusible pet toy, according to some embodiments of the present disclosure;

FIG. 6 is a graphical representation of an alarm system, according to some embodiments of the present disclosure;

FIG. 7 is a flowchart of a method for training a pet, according to some embodiments of the present disclosure;

FIG. 8 is a block diagram of a system for training a pet, according to some embodiments of the present disclosure.

### DETAILED DESCRIPTION

Caretakers may wish to train pets not to engage in destructive behaviors in response to exciting stimuli. Caretakers may also wish to avoid punishing pets for exhibiting excitement. Rather than provide negative reinforcement, caretakers may instead wish to redirect their pets' excited energy. In short, caretakers may wish to provide an alternative, positive outlet for the pets' energy—a new “task” for pets to direct the excitement toward.

However, communication between caretakers and pets is limited. Pets largely learn new behaviors based on repetition and pattern recognition. Therefore, such redirection calls for consistent motivation towards more desirable behaviors. Moreover, any motivation toward more desirable behaviors is preferably applied nearly every time a pet is confronted with exciting stimuli. In this way, pets can be trained to associate exciting stimuli with positive behaviors and redirect their destructive energy towards more productive tasks. It may therefore be advantageous to regularly provide motivation towards a desirable alternative outlet in response to exciting stimuli, to train the domestic pet to associate those stimuli with that alternative outlet.

However, further complicating this issue, caretakers are often otherwise occupied or unable to distract their domestic pets. In this scenario, it may be desirable to provide a source of stimulation that is partially automated. Alternatively, caretakers themselves may be the source of the pet's excitement. For example, a caretaker returning home may excite their pet. In this example, caretakers may be occupied with other tasks and therefore would be unable to personally redirect the energy of their pet. In this scenario, it may be desirable to provide a source of stimulation that is both automated and remote to the caretaker, thereby redirecting the pet's excitement without the caretaker's direct intervention.

On-demand remote distraction, fixed to a specific location, is an outstanding problem. Domestic pets, particularly, for example dogs, often react strongly to certain routine events. These exciting stimuli can lead to undesirable behaviors. For example, a pet may react strongly to anyone opening the entryway of its residence. In response to a stranger, the pet may even react aggressively. Alternatively, in response to the pet's caretaker, the pet may respond with significant enthusiasm. These excited reactions, both aggression and enthusiasm, may be undesirable. An over-excited pet may harm itself, others, or property. The caretaker of the pet may therefore wish to discourage such behaviors. Rather than provide negative reinforcement, it can be desirable to provide an alternative form of stimulation to the pet. By training the pet to associate an exciting stimulus, such as an entryway door opening, with a desirable task, such as locating and enjoying a reward, the pet's energy may be redirected. This, in turn, can reduce the risk of harmful interactions. The pet can learn to devote its energy to the reward, rather than the source of its potentially problematic behavior. Furthermore, by fixing the location of that reward to a single position, the pet may be physically directed away from undesirable locations, such as the busy entryway of a residence.

The present disclosure provides systems and methods for training a pet to respond positively to exciting conditions. A food-infusible pet toy may be housed within an enclosure and may be fixed to the enclosure (e.g., to the floor, walls, or ceiling of the enclosure). A remote control, for example a radiofrequency or infrared transmitter, may be in communication with the enclosure. In response to a user input, provided through the remote control, the enclosure may open, rendering the food-infusible pet toy accessible to the pet. The enclosure, when opened, may be large enough to accommodate the entire pet, or may be large enough to accommodate a pet's head—in either case, the food-infusible pet toy may be enjoyed by the pet when the enclosure is opened. A caretaker may provide the user input through the remote control in response to exciting conditions, for example, a stranger entering the home or the caretaker returning to the home. Alternatively, a caretaker may configure the enclosure to open automatically in response to a wireless signal triggered by those same conditions. The system may further include an alarm to alert the pet to the accessibility of the food-infusible pet toy. The alarm may be configured to alert the pet prior to the enclosure opening, contemporaneously with the enclosure opening, or after the enclosure opens. As the pet is repeatedly alerted to the accessibility of the food-infusible pet toy by the alarm, the pet can come to associate the alarm (and therefore the exciting conditions) with the positive, non-destructive behavior of enjoying the food-infusible pet toy. Additionally, if the food-infusible pet toy is fixed to the enclosure, the pet may not remove the food-infusible pet toy from the enclosure. The food-infusible pet toy may be fixed to the enclosure by a removeable coupling, such as one or more hand screws, a lock-and-key mechanism, or a double-sided spring-loaded mechanism. As these removeable couplings are generally difficult for a pet to uncouple, while amenable to uncoupling via human dexterity, the pet may be required to remain at the location of the enclosure to enjoy the food-infusible pet toy. By providing consistent positive stimulation, fixed to a location, in response to exciting stimuli, the systems and methods of the present disclosure may train a pet to associate those exciting stimuli with positive behaviors.

Various features may accommodate pets of different species, breeds, or physical capabilities. For example, the floor of the enclosure may be adjustable by height to accommodate pets of various sizes. As another example, the alarm may be configured to emit auditory, visual, olfactory, or other signals perceptible to a pet. By providing for various adjustments to the physical abilities and characteristics of various pets, the systems and methods of the present disclosure may be applied to a wide range of pets.

Additional features may improve the experience of human users. For example, a portion of the roof of the enclosure may be removeable and may therefore allow easier access to the interior of the enclosure for maintenance. As another example, a portion of the floor of the enclosure may be removeable and may therefore allow easier access to the food-infusible pet toy for cleaning or refilling with food. As another example, the conditions which cause the alarm to activate and door to open may be configurable by the user. By providing users easy access to the interior of the enclosure and user-configurable settings, the systems and methods of the present disclosure may be more conveniently applied.

The present disclosure therefore allows caretakers to remotely engage pets with positive outlets in response to various exciting stimuli. Moreover, by repeatedly providing inputs following particular exciting conditions, caretakers can train pets to associate those exciting conditions with non-destructive, positive behaviors. Namely, the pet can be trained to associate the exciting conditions with seeking out and then enjoying the food-infusible pet toy. Because the food-infusible pet toy is located within the enclosure, this association, alongside the placement of the enclosure, allows caretakers to consistently remove pets from undesirable locations.

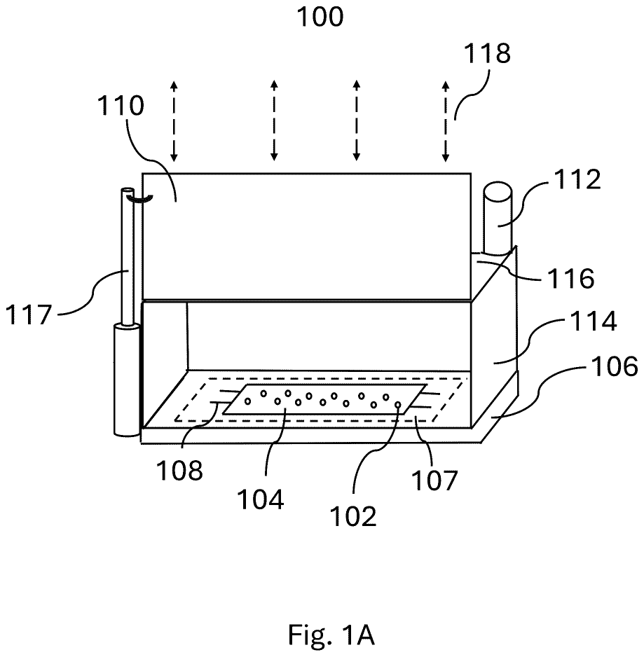

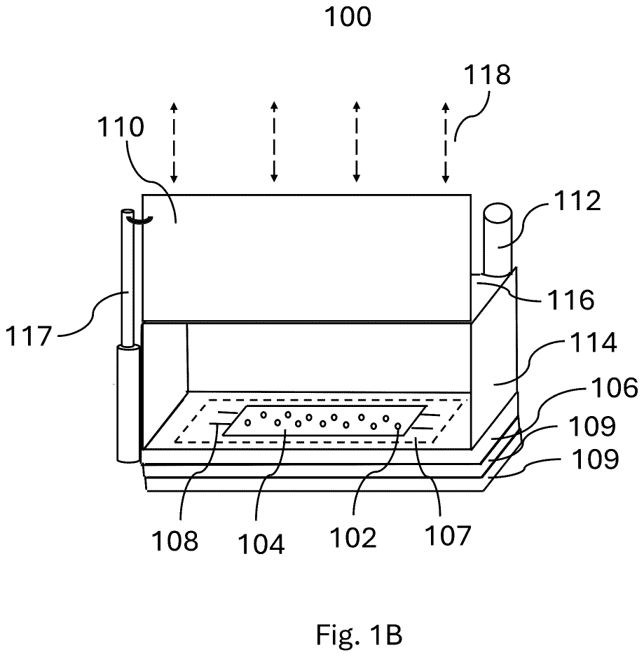

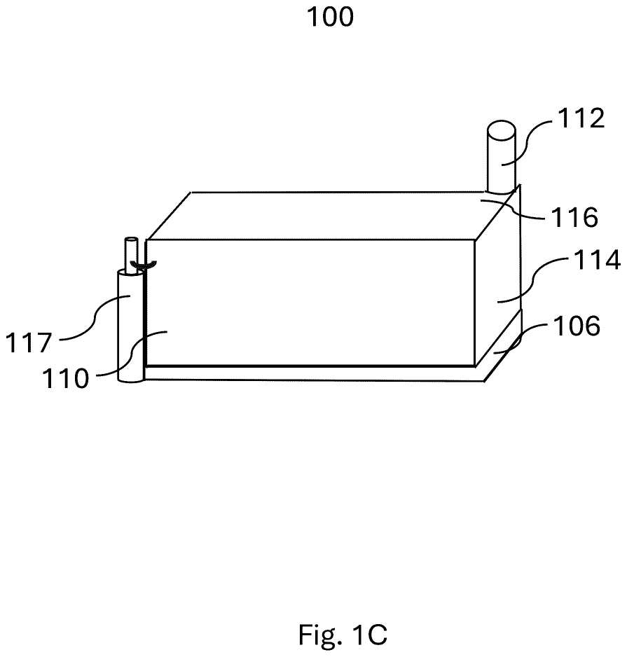

FIGS. 1A, 1B, and 1C are graphic representations of system 100, according to some embodiments of the present disclosure. System 100 includes food-infusible pet toy 102; an enclosure defined by floor 106, walls 114, roof 116, and door 110; and alarm 112. Floor 106 can include additional panels 109, elevating the enclosure. FIG. 1A depicts system 100 where door 110 is open and floor 106 does not include interlocking panels 109. FIG. 1B depicts system 100 where door 110 is open and floor 106 includes additional interlocking panels 109. FIG. 1C depicts system 100 where door 110 is closed and floor 106 does not include interlocking panels 109.

Food-infusible pet toy 102 may be substantially covered by or filled with food items desirable and edible to pets. For example, food-infusible pet toy 102 may be substantially covered with or filled with peanut butter, frozen berries, banana, or pumpkin. Food-infusible pet toy 102 may itself be made of inedible, non-toxic material and includes a plurality of texture elements 104. Texture elements 104 (such as convex indents, concave bumps, flexible ridges, and/or slits) may be included to stimulate pets. Texture elements 104 may advantageously increase the surface area of the food-infusible pet toy 102 and ensure adequate adhesion of food items. Food-infusible pet toy 102 may therefore provide the pet incentive to seek out the food-infusible pet toy through pleasurable olfactory, gustatory, and tactile feedback. This stimulation allows the pet to associate the food-infusible pet toy with a positive experience. Therefore, the pet can learn to seek out the food-infusible pet toy 102.

System 100 includes a substantially enclosed volume to prevent the pet from accessing pet toy 102 when door 110 is closed. Floor 106, walls 114, and roof 116 define a box which substantially surrounds food-infusible pet toy 102. Floor 106 is coupled with walls 114 which are coupled to roof 116. Floor 106, walls 114 and roof 116 may, for example, be coupled by a miter joint, screw, glue, or comprise a substantially continuous body of molded plastic. Walls 114 and roof 116 therefore substantially enclose the internal volume of system 100. Floor 106, walls 114, and roof 116 are coupled with door 110. One or more of floor 106, walls 114, and roof 116 may, for example, be coupled with door 110 by a hinge, runner, latch, or roller. Door 110 is configured to move between an open position (wherein the internal volume of the enclosure is exposed) and a closed position (wherein the internal volume of the enclosure is inaccessible). Door 110 may, for example, open using a linear or rotary actuator, which may, for example, be pneumatically, hydraulically, or electrically powered. As used throughout this specification, an actuator generally refers to a component operable to generate force along an axis or torque about an axis. A linear actuator refers to a component operable to displace door 110 through the application of linear force. By, for example, driving a rod connected to door 110 upward or downward. A rotary actuator refers to a component operable to displace door 110 through the application of torque. By, for example, rotating while in contact with door 110. System 100 includes linear actuator 117. In the exemplary system of FIGS. 1A, 1B, and 1C door 110 opens along axis 118, which is substantially perpendicular to floor 106. Floor 106, walls 114, roof 116, and door 110 may be constructed from rigid plastic, wood, metal, or any material sufficient to render the internal volume of the enclosure impenetrable to pets when the door 110 is in the closed position. Walls 114 and roof 116 therefore prevent pets from accessing food-infusible pet toy 102 when door 110 is in the closed position.

Food-infusible pet toy 102 is removably coupled to floor 106 of the enclosure by couplings 108. Couplings 108 may, for example, be a lock-and-key mechanism, a double-sided spring-loaded mechanism, hook and loop fasteners, plastic clips, buttons, magnets, ties, buckles, or hand screws. Because food-infusible pet toy 102 is coupled to floor 106, the pet engages with the toy at the location of system 100. Because couplings 108 such as a lock-and-key mechanism, a double-sided spring-loaded mechanism, or hand screws are generally not susceptible to uncoupling by a pet, instead typically requiring human dexterity to remove, the pet may not remove food-infusible pet toy 102 from the enclosure. The pet may therefore be stimulated at a fixed location determined by the placement of the enclosure. For example, the user may place the enclosure away from the busy entryway of the user's home. As the pet learns to seek out food-infusible pet toy 102 based on the positive associations described above, the pet can be trained to consistently seek stimulation at the fixed location determined by the placement of the system. The coupling of the food-infusible pet toy to the floor of the enclosure therefore allows the user to remove the pet from undesirable locations. Additionally, because food-infusible pet toy 102 is removably coupled to floor 106, the user can extract food-infusible pet toy 102 to cover, fill, or otherwise infuse food-infusible pet toy 102 with food, or to wash food-infusible pet toy 102 to ensure proper hygiene.

As shown by FIG. 1A, portion 107 of floor 106 is removeable. Portion 107 of floor 106 may be removed to clean floor 106 to ensure proper hygiene. Portion 107 of floor 106 may also be removed to allow for easier replacement of pet infusible pet toy 102. Portion 107 of floor 106 may be secured to system 100 by, for example, clips, buttons, magnets, ties, buckles, or hand screws.

As shown by FIG. 1B, floor 106 can also be adjusted by height to improve the accessibility of the food-infusible pet toy 102. In system 100, the floor 106 is adjusted by interlocking panels 109. Panels 109 are configured to attach to floor 106 or another panel 109. Adjustments by height may also be accomplished by various components, such as a collapsible floor or telescopic legs. The enclosure can be suspended from a ceiling other overhead mounting point, attached to a wall, set on a shelf or piece of furniture, or the like. For example, floor 106 may be set to a low height to allow a small breed or adolescent pet to access food-infusible pet toy 102 when door 110 is in the open position. Alternatively, floor 106 may be set to a high height to allow a large breed pet to comfortably access food-infusible pet toy 102 when door 110 is in the open position. For small breed or adolescent pets, floor 106 may be set to a height of three inches. For large breed pets, the floor may be set to a height of one foot. In some embodiments, the floor is set to a height of six inches. For pets with flying or climbing capabilities, floor 106 may be set significantly higher to avoid occupying floor space. Additionally, the enclosure may be various sizes to accommodate larger or smaller pets or uses. For example, the enclosure may define an internal volume of more than fifteen cubic feet, allowing most large breed pets to fit comfortably within the enclosure. Alternatively, the enclosure may defined an internal volume of three cubic feet, allowing only a portion of the pet to fit within the enclosure. Any size sufficiently large enough to accommodate access to the food-infusible pet toy 102 is sufficient.

FIG. 1C is a graphic representation of system 100, wherein door 110 is in the closed position. As shown by FIG. 1C, when door 110 is in the closed position, food-infusible pet toy 102 is substantially surrounded by system 100 and inaccessible to the pet. In response to a remote user input provided, for example, through a remote control, smartphone application, or control panel, alarm 112 activates. User input may also be automatically transmitted following a preconfigured condition, such as a doorbell ringing or a door opening. In this case, a user may operably couple the remote control to a sensor configured by the user to trigger the user input. The sensor may be, for example, an infrared motion detector at a doorway, a pressure sensor at an entryway, or a microphone configured to activate the alarm 112 in response to the sound of a doorbell.

The alarm 112 emits a signal perceptible to a pet when activated. The signal perceptible to a pet may be, for example, an auditory alarm, such as a sound or tone at a dog pitch; a visual indicator, such as a flashing light; an olfactory alarm, such as atomized scented water from a nozzle; or other sensory indicators, such as a vibration. Dog pitch in this context refers to frequencies of sounds that are generally inaudible to humans yet perceptible by dogs and other domestic pets, such as the frequency range spanning 23 to 54 kHz.

Door 110 is also configured to open in response to the user input, either prior to the alarm, contemporaneously with the duration of the alarm, or after the alarm. In system 100, door 110 is opened and closed by the action of actuator 117. As door 110 opens, food-infusible pet toy 102 is rendered accessible to the pet. Because food-infusible pet toy 102 is inaccessible to the pet when door 110 is in the closed position, and door 110 is configured to open either before, during, or after alarm 112 is activated, the pet can be trained to associate the alarm signal with access to food-infusible pet toy 102. Because food-infusible pet toy 102 is designed to create positive associations in the pet, the pet can therefore learn to associate the alarm with those positive associations. The pet can therefore be trained over time to seek out food-infusible pet toy 102 in response to the alarm signal. This in turn allows system 100 to divert the attention of the pet to system 100 in response to the alarm signal. Because food-infusible pet toy 102 is coupled to floor 106 of system 100, the attention of the pet is diverted to a fixed location determined by the location of system 100. In system 100, door 110 is configured to open along axis 118 substantially perpendicular to the plane defined by floor 106.

Door 110, once open, is also configured to close, either following a length of time or a user-defined condition. For example, door 110 may be closed by the action of actuator 117 following a period of 3 minutes, 5 minutes, or 10 minutes. As another example, door 110 may be configured to close following a period of time after the alarm was activated, as set by the user. Prior to closing, alarm 112 may be configured to reactivate. Alarm 112 may therefore warn the pet that the door 110 is closing, motivating the pet to move from the path of the closing door. When reactivated, alarm 112 may emit a signal perceptible to pets distinct from the previous signal. By emitting a distinct signal, alarm 112 may avoid confusing the pet.

It is to be understood that FIGS. 1A-1C are illustrative embodiments of the present disclosure, and that various alternatives are possible without departing from the scope or spirit of the disclosure.

For example, while food-infusible pet toy 102 of FIGS. 1A, 1B, and 1C has been described as fixed to floor 106 of system 100, food-infusible pet toy 102 may be fixed to other portions of system 100, such as walls 114 or ceiling of system 100.

Additionally, while system 100 has been described as a box or rectangular prism, other geometries that could substantially enclose and subsequently expose food-infusible pet toy 102 are contemplated. For example, walls 114 may be angled to be non-perpendicular with the plane defined by floor 106, or roof 116 may be angled to be non-parallel with the plane defined by floor 106. Alternative geometries may improve the accessibility of the system to pets or humans. Alternative geometries may also allow installation of the system at more varied locations throughout the home environment of a pet.

Additionally, while door 110 has been shown as opening along axis 118 substantially perpendicular to floor 106, door 110 could also be configured to open along, about, or around other axes. For example, door 110 may open by rotating about a hinge, sliding along a runner, or coiling above an opening.

Furthermore, while door 110 has been shown as perpendicular to floor 106 and distinct from roof 116, other configurations are contemplated. For example, door 110 could also serve as roof 116 (i.e., door 110 could be parallel to the floor 106 and/or sit substantially atop four stationary walls 114).

Moreover, while system 100 has been shown as including a single door 110, additional configurations for exposing the interior volume of the enclosure are contemplated. For example, a portion of roof 116 may be configured to move along or about an axis, exposing the interior volume of the enclosure.

Additionally, while alarm 112 has been described as including an auditory or visual signal, other signals perceptible to a pet are contemplated. For example, alarm 112 may include an olfactory element, such as emissions from an atomizer. Moreover, alarm 112 may include a combination of signals perceptible to a pet, such as simultaneous visual, vibratory, auditory, and/or olfactory signals, or any combination of the preceding.

Furthermore, while alarm 112 has been shown as connected to roof 116, other placements of alarm 112 are contemplated. For example, alarm 112 may be coupled to walls 114, coupled to door 110, or internal to the enclosure. Alarm 112 may, for example, be coupled by glue, screws, or lacquer. Alternatively, alarm 112 may be substantially surrounded by the material defining the enclosure, such as molded plastic, wood, or metal.

Additionally, while system 100 has been described as substantially enclosing the volume defined by floor 106, walls 114, and roof 116, it is also contemplated that the enclosure could omit roof 116. For example, walls 114 may be sufficiently high to render food-infusible pet toy 102 inaccessible to pets. Additional or alternative modes of containment are contemplated, such as an enclosure where one or more boundaries of the enclosure are defined by a pre-existing structure, such as a wall, furniture, a closet, or a room. In some embodiments, a virtual enclosure may be defined using, for example, an electronic or invisible pet fence.

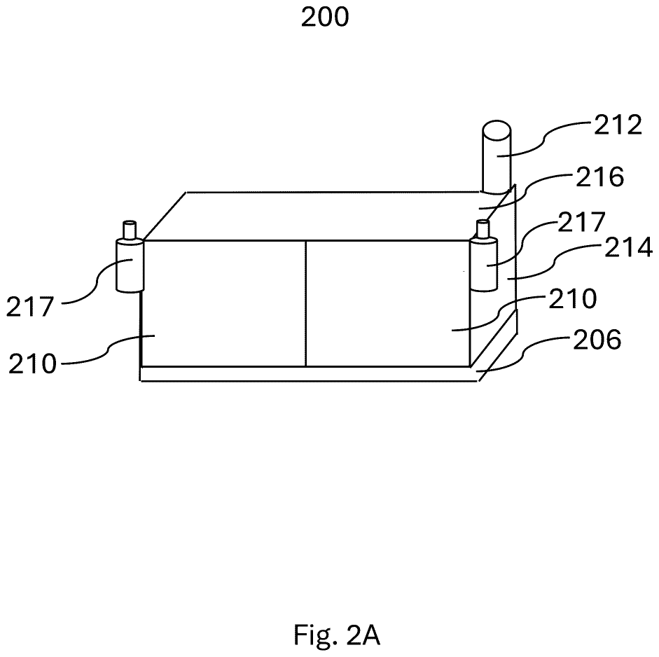

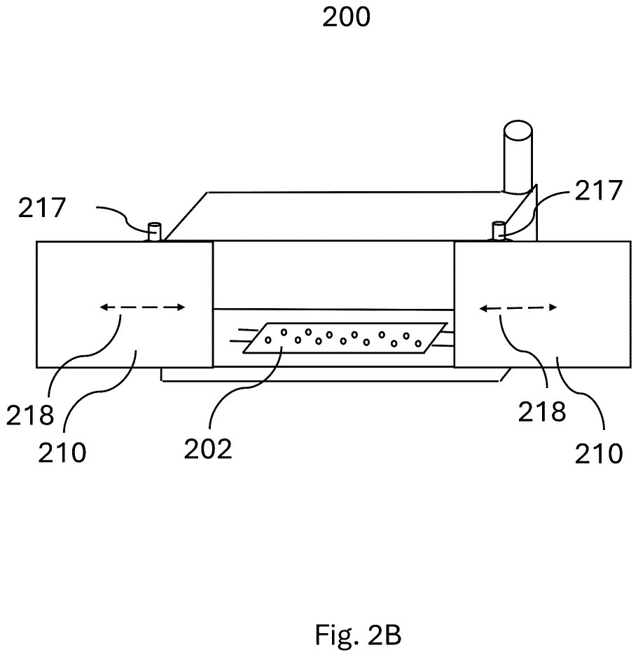

FIGS. 2A-2B are graphic representations of another system 200, according to some embodiments of the present disclosure. System 200 includes food-infusible pet toy 202, door 210, floor 206, walls 214, roof 216, alarm 212, and actuator 217. As shown by FIG. 2, the enclosure includes door 210 made of two panels. In system 200, door 210 is configured to open in response to the action of actuators 217. In system 200, the actuators 217 are rotary actuators. As defined above, rotary actuators are a component operable to apply torque. In system 200, actuators 217 rotate to open door 210. The panels are configured to open along an axis 218 substantially parallel to the plane defined by floor 206 as actuators 217 rotate. Alternatively, door 210 may be configured to open by rotating about hinges either outwardly or inwardly. In system 200, door 210 therefore opens without increasing the total height of the system. System 200 can therefore be advantageously installed in areas with lower vertical clearance.

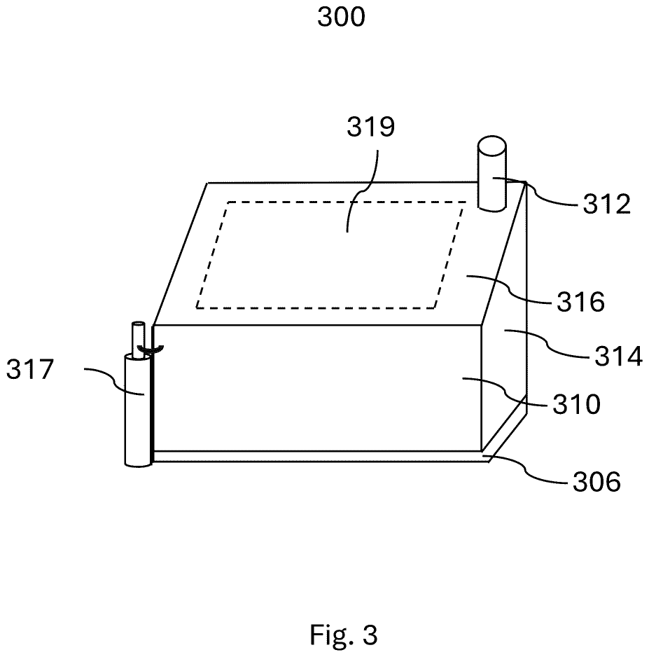

FIG. 3 is a graphic representation of another system 300, according to some embodiments of the present disclosure. System 300 includes door 310, floor 306, walls 314, roof 316, alarm 312, actuator 317, and removeable portion 319 of roof 316. In system 300, roof 316 is slanted, forming an acute angle with the plane defined by floor 306. Portion 319 of roof 316 can be removed from system 300. Portion 319 of roof 316 can be removed to allow a human user to access the interior of the enclosure. Portion 319 of roof 316 can therefore allow more convenient access to the interior of the enclosure for maintenance, cleaning, or refilling a food-infusible pet toy. The angle formed by roof 316 can advantageously increase the height of portion 319 and therefore better enable a human-user to access the enclosure. Removeable portion 319 of roof 316 may be connected to roof 316 by, for example, hook and loop fasteners, hinges, snaps, ties, or hand screws.

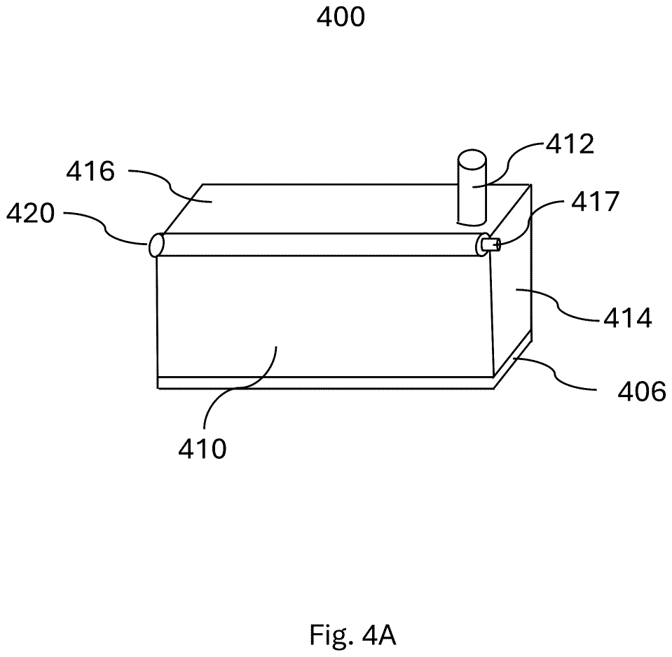

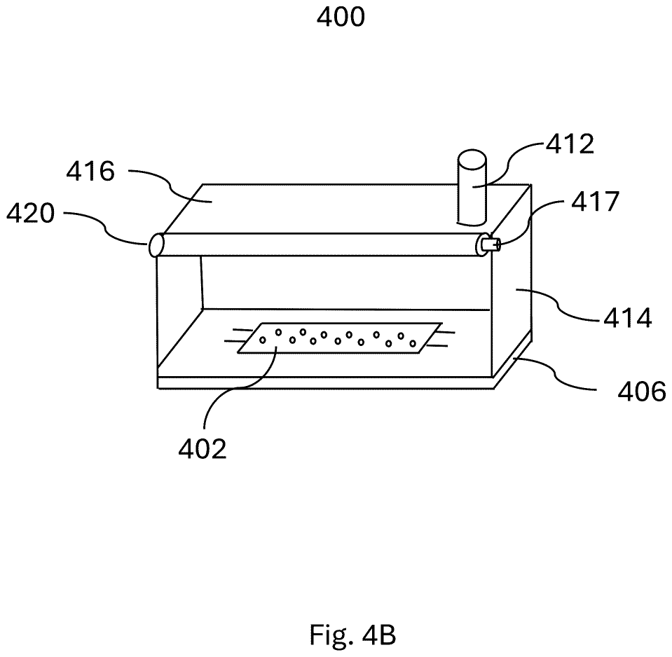

FIGS. 4A and 4B are graphic representations of another system 400, according to some embodiments of the present disclosure. System 400 includes food-infusible pet toy 402, floor 406, door 410, alarm 412, roof 416, actuator 417, and roller 420. As shown by FIGS. 4A and 4B, door 410 is in contact with roller 420. Door 410 is configured to be flexible. Door 410 may be flexible plastic, vinyl, or made of multiple panels. In the closed position, shown in FIG. 4A, door 410 is substantially perpendicular to floor 406. In the open position, shown in FIG. 4B, door 410 is repeatedly wrapped around roller 420 by the action of actuator 417. In system 400, actuator 417 is a rotary actuator, as defined above. When door 410 is in the open position, food-infusible pet toy 402 is accessible to pets. In system 400, door 410 therefore opens without increasing the total height of the system. System 400 may therefore be advantageously installed in areas with lower vertical clearance. In system 400, door 410 may also be constructed of lightweight materials. Door 410 may therefore reduce the total weight of the system, allowing for easier installation.

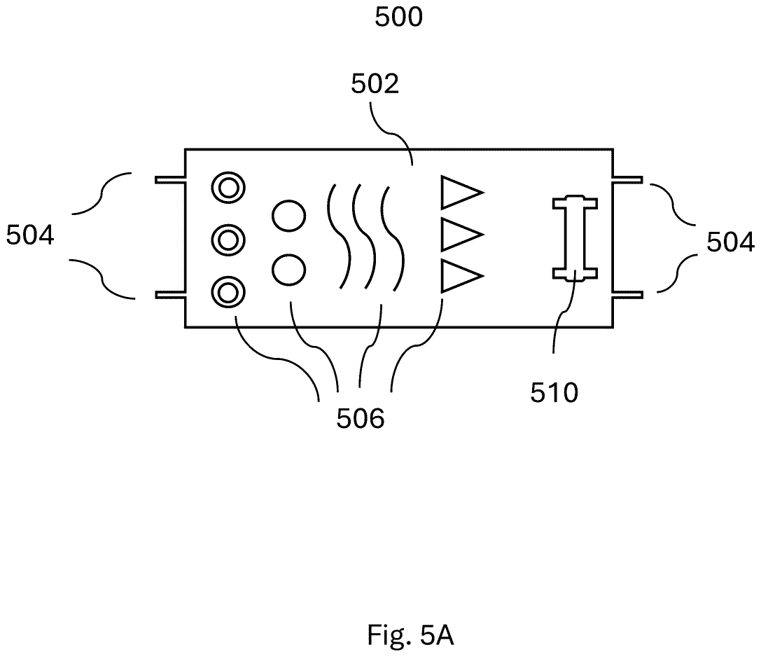

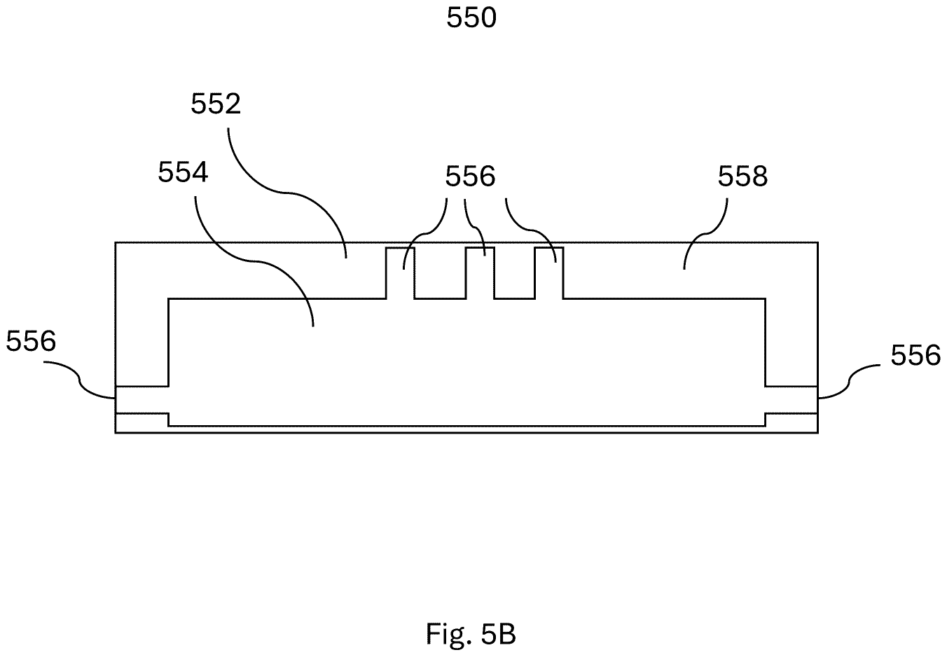

FIG. 5A is a graphic representation of food-infusible pet toy 500, according to some embodiments of the present disclosure.

Food-infusible pet toy 500 may be comprised of non-toxic, inedible material 502. Inedible materials may generally refer to materials not intended for consumption by a pet. Non-toxic materials may generally refer to materials that are not toxic for the pet at issue, such as a dog. Exemplary materials that form food-infusible pet toy 500 include BPA-free materials, phthalate-free materials, lead-free materials, plastic, resin, rubber, nylon, synthetic fibers, antler, bone, or cartilage.

Food-infusible pet toy 500 may include removable couplings 504, configured to allow the food-infusible pet toy 500 to be manually attached to or removed from the enclosure systems described above. Removable couplings preferably attach food-infusible pet toy 500 to an enclosure system in such a way that a pet is incapable of removing or is unlikely to remove food-infusible pet toy 500 from the enclosure system or its vicinity, while being capable of detachment by a human from the enclosure system. For example, removable couplings may require manipulation via human manual dexterity to switch the couplings between coupled and uncoupled states. Removable couplings 504 may, for example, be comprised of a lock-and-key mechanism, a double-sided spring-loaded mechanism, hook and loop fasteners (e.g., Velcro), plastic clips, buttons, magnets, ties, buckles, or hand screws.

Food-infusible pet toy 500 may include variable texture elements 506, to stimulate a pet or host various food items. Texture elements 506 may take a variety of shapes. Texture elements 506 may, for example, include convex indents, concave bumps, flexible ridges, and/or slits. Convex texture elements may protrude from the non-toxic, inedible material 502. Concave texture elements may include indents in the non-toxic, inedible material 502. Texture elements 506 may therefore advantageously increase the surface area of the food-infusible pet toy 500 to improve adhesion of food items and provide pleasurable tactile sensations to pets. Food-infusible pet toy 500 may include handle 510, provided to improve the process of cleaning or maintaining food-infusible pet toy 500. For example, by engaging with handle 510, a user may clean the food-infusible pet toy 500 without contacting texture elements 506.

FIG. 5B is a graphic representation of an alternative food-infusible pet toy 550. Food-infusible pet toy 550 includes a hollow interior 554 substantially surrounded by the non-toxic, inedible material 552, as shown in FIG. 5B. This hollow interior may be accessed by a slit or opening, such as openings 556 located at various points along the perimeter of food-infusible pet toy 550. The hollow interior of food-infusible pet toy 550 may be filled with food desirable and edible to pets, such as peanut butter, frozen berries, or pumpkin. By placing food within hollow interior 554 of food-infusible pet toy 550, rather than exclusively on its outer surface, food-infusible pet toy 550 may provide additional stimulus to pets as those pets attempt to extract the food from hollow interior 554. Because hollow interior 554 is only partially accessible, food-infusible pet toy 550 may slow a pet's consumption of food within hollow interior 554. Food-infusible pet toy 550 therefore advantageously allows for pets to be distracted for longer periods of time while working to remove the food from hollow interior 554.

While FIG. 5B depicts food-infusible pet toy as including multiple openings 556, alternate means of access are contemplated. For example, a single opening 556 may be provided to further limit access to food items within hollow interior 554. Alternatively, openings 556 may be replaced with a mesh layer or other semi-permeable layer enabling limited access to hollow interior 554.

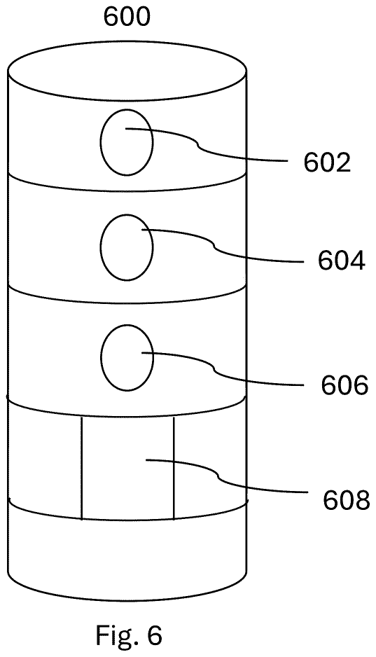

FIG. 6 is a graphic representation of alarm system 600, according to some embodiments of the present disclosure. Alarm system 600 includes audio elements 602, configured to provide a signal audible to a pet. Audio elements 602 may be, for example, a speaker, transducer, or mechanical audio element such as a bell, clicker, or buzzer. For example, audio elements 602 may emit a sound or tone at a dog pitch, prerecorded alarm tone, or vibration. Example alarm system 600 further includes visual indicators 604, configured to provide a visual indication perceptible to a pet. For example, visual indicators 604 may be LEDs, filament light bulbs, or other electromechanical elements. Alarm system further includes olfactory elements 606, configured to provide an olfactory indicator to a pet. Olfactory elements 606 may be, for example, an atomizer, vaporizer, or sprinkler. Olfactory elements 606 may draw from a reservoir of non-toxic scented liquids. By presenting audio, visual, vibratory, and/or other sensory indicators (e.g., odors) perceptible to the pet, alarm system 600 allows the pet to create associations between the alarm signal and access to the food-infusible pet toy described above. Alarm system 600 therefore allows the pet to be trained to seek out the food-infusible pet toy in response to the audio, visual, vibratory, and/or other sensory indicator.

Alarm system 600 further includes receiver 608. Receiver 608 is configured to receive remote inputs from the user. For example, receiver 608 may be configured to accept radio frequency or infrared signals over Bluetooth, Wi-Fi, or other wireless protocols. Receiver 608 may include an antenna, infrared sensor, and internal circuitry depending on the wireless protocol. In response to user input, receiver 606 may be further configured to trigger audio elements 602, visual indicator 604, and/or olfactory elements 606. In response to user input, receiver 608 may be further configured to move the door of the various systems described above to the open position. Furthermore, alarm system 600 may be configured to emit audio, visual, olfactory, or other sensory signals according to user-defined settings. For example, alarm may be configured to emit only audio signals based on user-preference.

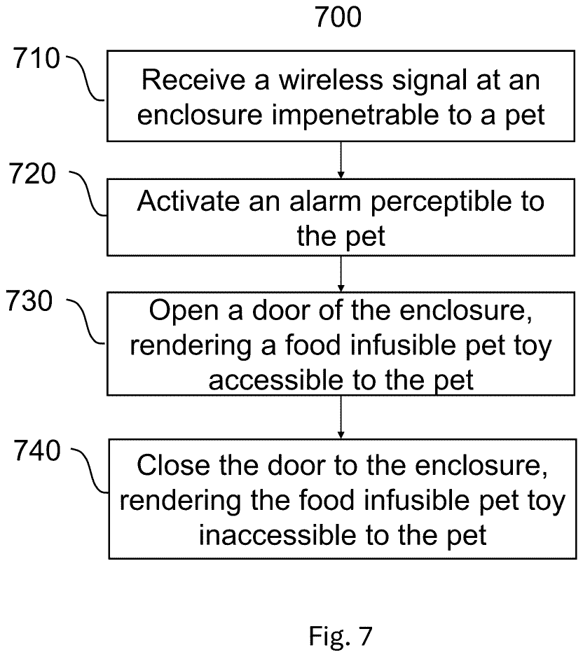

FIG. 7 is a flow diagram of example pet training method 700 according to some embodiments of the present disclosure. Pet training according to method 700 can provide remote, on-demand stimulation of pets and provide positive outlets for reactions to exciting stimuli.

At step 710, a wireless signal is received at a system (such as system 100). The wireless signal may, for example, be provided by remote control. The wireless signal may, for example, be comprised of a radiofrequency or infrared signals transmitted over Bluetooth, Wi-Fi, or other wireless protocols. The remote control may, for example, be a handheld device, a smartphone application, or other wireless transmitter. A human-user may interact with the remote control, and provide the wireless signal, in order to distract a pet towards the location of the system. By initiating the method 700 using a wireless signal, the method 700 allows for the remote stimulation of pets. The wireless signal may also be transmitted by remote control automatically following a user-defined condition, such as a doorbell ringing or a door opening. In this case, a user may operably couple the remote control to a sensor configured to trigger the wireless sensor. The sensor may be, for example, an infrared motion detector at a doorway, a pressure sensor at an entryway, or a microphone configured to activate the alarm in response to the sound of a doorbell.

At step 720, in response to the wireless signal, an alarm (such as alarm 112) is activated. The alarm may be any auditory, visual, vibratory, or other suitable sensory indicator perceptible to a pet. For example, the alarm may be a sound in the “dog pitch” range, or between 23 and 54 kHz. Notably, this range is beyond the typical range of frequencies audible to a human. Alternatively, the alarm may be the activation of visual indicators such as LEDs, filament bulbs, or other electromechanical elements. Additionally, the alarm may, for example, be any combination of perceptible elements, such as a combination of visual and auditory elements. In some embodiments, the combination of perceptible elements may be adjusted based on user preference and/or pet preference. By providing diverse stimuli, the alarm may better capture the attention of pets or capture the attention of pets with sensory disabilities. Additionally, the alarm may be configured to activate for various lengths of time. For example, the alarm may be configured to sound for one minute, 30 seconds, or 10 seconds. In some embodiments, the duration of the alarm may be adjusted based on user preference. In some embodiments, the alarm may automatically turn off in response to, e.g., detecting that the pet has entered the enclosure.

At step 730, also in response to the wireless signal, a door (such as door 110) to an enclosure is opened. Opening the door exposes the interior of the enclosure, exposing a food-infusible pet toy (such as food-infusible pet toy 102). The door may, for example, open using a linear or rotary actuator, which may, for example, be pneumatically, hydraulically, or electrically powered. The door may, for example, open by rotating about a hinge, sliding along a runner, or coiling above an opening. In embodiments that use an electronic or invisible pet fence, the door may be opened by disabling all or a portion of the fence. By exposing the food-infusible pet toy, the system provides pets an incentive to seek out the system in response to the alarm.

In some embodiments, step 730, opening the door, may occur before step 720, activating the alarm. In other embodiments, step 730, opening the door, may occur contemporaneously with step 720, activating the alarm. In some embodiments, step 730, raising the door, may occur after step 720, activating the alarm.

Following step 730, the door of the enclosure may remain open for a predetermined length of time. For example, the door of the enclosure may remain open for five minutes, one minute, or 30 seconds. In some embodiments, the length of time the door remains open may be adjusted based on user preference.

At step 740, following the predetermined length of time or the second wireless signal, the door to the enclosure is closed. The food-infusible pet toy is fixed to the interior of the enclosure and therefore step 740 cuts off a pet's access to the food-infusible pet toy. By removing the pet's access to the food-infusible pet toy, the system can improve the longevity of the food-infusible pet toy by reducing wear and tear. By fixing the food-infusible pet toy to the interior of the enclosure, the system can also hold the pet's attention at a fixed location for the duration of method 700.

In some embodiments, step 740, closing the door, may be preceded by a repetition of step 720, activating the alarm. In other embodiments, the repetition of step 720, activating the alarm, may include activating a distinct sensory signal perceptible to a pet. The repetition of step 720, activating the alarm, may warn a pet that the door is closing, motivating the pet to move from the path of the closing door. By emitting a distinct signal, alarm may avoid confusing the pet.

In some embodiments, the system may be configured to close the door of the enclosure in response to a second wireless signal received from the remote control. The second wireless signal may, for example, be comprised of a radiofrequency or infrared signals transmitted over Bluetooth, Wi-Fi, or other wireless protocols. A user may interact with the remote control to trigger the second wireless signal, for example, after exciting stimuli are no longer present to upset a pet.

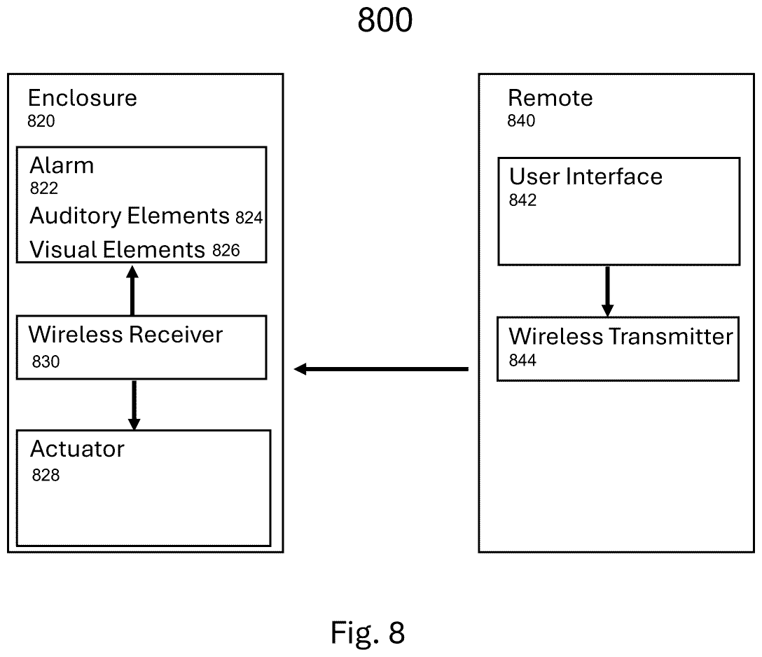

FIG. 8 is a block diagram of the components of system 800 using which various embodiments of the present disclosure may be practiced. System 800 includes at least one enclosure 820. The system further includes at least one remote 840 communicably coupled with enclosure 820.

Enclosure 820 of system 800 includes several elements. Enclosure 820 includes alarm 822, which further includes of auditory elements 824 and visual elements 826. Enclosure 820 includes actuator 828. Enclosure 820 also includes wireless receiver 830. Wireless receiver 830 is communicably operatively coupled with alarm 822 and actuator 828. In response to a wireless signal, wireless receiver 830 can cause alarm 822 to activate. In response, alarm 822 can emit auditory and visual indicators through auditory elements 824 and visual elements 826, respectively. In response to a wireless signal, wireless receiver 830 can also cause the actuator 828 to activate. In response, actuator 828 can cause the door of the enclosure to open. Although alarm 822, wireless receiver 830, and actuator 828 are depicted in FIG. 8 as being located within enclosure 820, it is to be understood that one or more of these components, all or in part, may be positioned external to enclosure 820. For example, one or more components may be adjacent to or attached to an exterior portion of enclosure 820. In some embodiments, alarm 822 may be distributed, for example, by causing one or more audio/visual devices located throughout the home to emit perceptible signals.

Remote 840 of system 800 also includes several elements. Remote 840 includes user interface 842. User interface 842 is operatively coupled with wireless transmitter 844. In response to user inputs, user interface 842 can cause wireless transmitter 844 to emit a wireless signal. User interface 842 can be, for example, a button, a switch, or a graphical user interface. System 800 further includes wireless transmitter 844. Wireless transmitter 844 is communicably coupled with wireless receiver 830. Wireless receiver 830 can receive wireless signals from wireless transmitter 844. User interface 842 may also be operable to configure wireless transmitter 844 to emit a wireless signal automatically following a condition, such as a doorbell ringing or a door opening. In this case, the remote control may be operably coupled to a sensor configured to trigger the wireless sensor. The sensor may be, for example, an infrared motion detector at a doorway, a pressure sensor at an entryway, or a microphone configured to activate the alarm in response to the sound of a doorbell. As the sensor is triggered, wireless transmitter 844 emits a wireless signal.

In some embodiments, portions of system 800 (e.g., logic for determining when to trigger an alarm in response to a wireless signal) may be carried out using one or more remote processors (e.g., in a cloud-based configuration or using a local network). Additionally, or alternately, system 800 may include one or more processors within or in proximity to enclosure 820 for carrying out functionality for receiving the wireless signal, triggering the alarm, and/or causing actuator 828 to open the door of enclosure 820.

While the systems and methods above have been particularly shown and described with reference to specific preferred embodiments, it should be understood by those skilled in the art that various changes in form and detail can be made therein without departing from the spirit and scope of the disclosure as defined by the appended claims. A person of ordinary skill in the art would understand from the present disclosure that the disclosed embodiments can be selectively combined without departing from the scope of the disclosure. Moreover, a person of ordinary skill in the art would understand that various exemplary implementations of the present disclosure could be varied without departing from the scope and spirit of the present disclosure and are merely provided here as non-limiting examples to aid implementation.

While embodiments of the present disclosure have described the food-infusible pet toy as inaccessible to a pet while the various systems described above are substantially surrounding the food-infusible pet toy, a person of ordinary skill in the art would understand that inaccessible may be interpreted as imperceptible, hidden, or otherwise shielded from a pet.

1. A system for training pets, comprising:
an enclosure, comprising:
a first wall;
a second wall, wherein a first edge of the second wall is coupled to a first edge of the first wall;
a third wall, wherein a first edge of the third wall is coupled to a second edge of the second wall;
a ceiling, wherein a first edge of the ceiling is coupled to a second edge of the first wall, a second edge of the ceiling is coupled to a third edge of the second wall, and a third edge of the ceiling is coupled to a second edge of the third wall;
a floor, wherein at least a portion of the floor is removably coupled to at least a third edge of the first wall, a fourth edge of the second wall, or a third edge of the third wall, wherein the floor has an adjustable height, and at least a portion of the floor is detachable from the enclosure;
a door, wherein the door is operably coupled to at least one of the first wall, second wall, third wall, ceiling, or floor such that the enclosure substantially surrounds a volume defined by the first wall, second wall, third wall, ceiling, floor, and door, wherein the door is configured to open to render an interior of the enclosure accessible and configured to close to render the enclosure impenetrable to pets;
an alarm, proximate to the enclosure, wherein the alarm is configured to emit a signal perceptible to a pet;
a food-infusible pet toy, located within the interior of the enclosure and removably coupled to the enclosure, such that, when the door is open, the food-infusible pet toy is accessible to the pet, the food-infusible pet toy comprising:
a non-toxic, inedible surface;
a handle, operably coupled to the non-toxic, inedible surface; and,
a plurality of texture elements, coupled to the non-toxic, inedible surface; and,
a control system, wherein the control system is configured to cause the door to open or close, and the alarm to emit the signal, in response to a user input.

2. The system of claim 1, wherein the signal perceptible to a pet is configured by a user to include at least one of an auditory, olfactory, visual, or vibratory signal.

3. The system of claim 1, wherein the food-infusible pet toy is removably coupled to the enclosure by at least one coupling requiring human manual dexterity to uncouple.

4. The system of claim 1, wherein the food-infusible pet toy is removably coupled to the enclosure by a key-locked mechanism.

5. The system of claim 1, wherein the food-infusible pet toy is removably coupled to the enclosure by a double-sided spring-loaded mechanism.

6. The system of claim 1, wherein a portion of the ceiling is removable.

7. The system of claim 1, wherein the door is further configured to open and the alarm is configured to emit a signal perceptible to a pet in response to a user-defined condition.

8. The system of claim 1, wherein the door is further configured to close following a user-defined condition.

9. The system of claim 8, wherein the user-defined condition is a length of time.

10. The system of claim 8, wherein the alarm is further configured to emit a signal perceptible to a pet prior to closing.

11-20. (canceled)

21. The system of claim 1, wherein the signal perceptible to a pet is an auditory signal inaudible to humans.

22. The system of claim 1, wherein the signal perceptible to a pet emitted prior to closing is distinct from the signal perceptible to a pet emitted in response to a user input.
